(19) United States
(12) Patent Application Publication
(10) Pub. No.: US 2018/0152840 A1
(43) Pub. Date: May 31, 2018

(54) WEARABLE APPARATUS, INFORMATION TERMINAL, COMMUNICATION SYSTEM, ELECTRONIC APPARATUS, AND COMMUNICATION CONTROL METHOD

(71) Applicant: SEIKO EPSON CORPORATION, Tokyo (JP)

(72) Inventor: Shintaro NAGASAKI, Hara-mura (JP)

(73) Assignee: SEIKO EPSON CORPORATION, Tokyo (JP)

(21) Appl. No.: 15/795,749

(22) Filed: Oct. 27, 2017

(30) Foreign Application Priority Data
Nov. 25, 2016 (JP) 2016-228799

(51) Int. Cl. H04W 12/06; H04W 40/02; H04W 48/18; H04W 88/06; H04W 8/00

(52) U.S. Cl. CPC H04W 12/06; H04W 40/02; H04W 48/18; H04W 4/008; H04W 8/005; A63B 2230/00; H04W 88/06

(57) ABSTRACT

A wearable apparatus includes a first communication unit that performs Wi-Fi communication with a gateway apparatus, a second communication unit that performs Bluetooth communication with an information terminal which can perform the Wi-Fi communication with the gateway apparatus, through Bluetooth communication, and a control unit that performs communication control on the first communication unit and the second communication unit, in which the second communication unit receives communication path information from the information terminal through the Bluetooth communication, and in which the control unit performs control of selecting either one of the Wi-Fi communication and the Bluetooth communication on the basis of the communication path information, and transferring transfer data.

### RELATED APPLICATIONS

This application claims priority to Japanese Patent Application No. 2016-228799, filed Nov. 25, 2016. The disclosure of this prior application is incorporated herein reference.

### BACKGROUND

### 1. Technical Field

The present invention relates to a wearable apparatus, an information terminal, a communication system, an electronic apparatus, and a communication control method.

### 2. Related Art

In recent years, a small apparatus which can perform communication according to a wireless communication method has been spread. For example, a device which can directly communicate with Wi-Fi™ even in a wearable apparatus which is driven with a restricted battery capacity such as a primary battery or a stereoscopic battery has appeared. Wi-Fi has a high communication speed, and can be used in a user's home, a free spot, or the like. Communication availability is considerably high since there are many spots working for twenty-four hours. However, communication with Wi-Fi requires considerable power consumption.

Such a wearable apparatus often employs a technology of Bluetooth Low Energy (hereinafter, referred to as BLE; Bluetooth is a registered trademark), and is thus often in an environment being normally connected to a smart phone so as to transmit and receive data to and from the smart phone at all times. However, a communication speed of BLE is much lower than that of Wi-Fi, and thus there is a defect that only restricted data can be transmitted and received.

It is necessary to select an appropriate communication path in a situation in which a plurality of wireless communication methods (communication paths) having different characteristics are considered.

JP-A-2014-143633 discloses a method in which, in a Wi-Fi Direct supported apparatus which can operate in both of a base station and a wireless LAN client, a connection target communication device is selected on the basis of input conditions. JP-A-2014-143633 also discloses that a wireless communication method can be extended to other standards such as Bluetooth.

In JP-A-2014-143633, a communication device is selected on the basis of information regarding whether a target apparatus is a base station or a wireless LAN client, or is a printer or a camera. However, in JP-A-2014-143633, an apparatus which can use a plurality of wireless communication methods is not expected, and a difference (power consumption, a communication speed, or the like) between the wireless communication methods is not taken into consideration. JP-A-2014-143633 is based on searching for Wi-Fi apparatuses, and power consumption in the search is not taken into consideration.

In other words, in the technique of the related art, there is no disclosure of a method of performing appropriate wireless communication in an apparatus which can use a plurality of wireless communication methods and is restricted in battery capacity.

### SUMMARY

An advantage of some aspects of the invention is to provide a wearable apparatus, an information terminal, a communication system, an electronic apparatus, and a communication control method, capable of selecting an appropriate communication path with low power consumption.

An aspect of the invention relates to a wearable apparatus including a first communication unit that performs Wi-Fi communication with a gateway apparatus; a second communication unit that performs Bluetooth communication with an information terminal which can perform the communication with the gateway apparatus; and a control unit that performs communication control on the first communication unit and the second communication unit, in which the second communication unit receives communication path information from the information terminal through the Bluetooth communication, and in which the control unit performs control of selecting either one of the Wi-Fi communication and the Bluetooth communication on the basis of the communication path information, and transferring transfer data.

In the aspect of the invention, the wearable apparatus which can perform Wi-Fi communication and the Bluetooth communication receives communication path information from the information terminal through the Bluetooth communication, and selects either one of the Wi-Fi communication and the Bluetooth communication on the basis of the communication path information. In the above-described way, some processes which are required to select a communication path can be performed by the information terminal, and thus it is possible to reduce power consumption in the wearable apparatus and also to select an appropriate communication path.

In the aspect of the invention, the second communication unit may receive authentication information which is used for an authentication process in the gateway apparatus in the Wi-Fi communication, through the Bluetooth communication, and the first communication unit may perform the Wi-Fi communication with the gateway apparatus on the basis of the authentication information.

In the above-described way, it is possible to acquire authentication information from the information terminal through the Bluetooth communication.

In the aspect of the invention, the second communication unit may receive the authentication information during pairing of the Bluetooth communication with the information terminal.

In the above-described way, it is possible to acquire authentication information during pairing.

In the aspect of the invention, the authentication information may include a service set identifier (SSID) and a password corresponding to the gateway apparatus.

In the above-described way, it is possible to acquire an SSID and a password as authentication information.

In the aspect of the invention, the second communication unit may perform a process of making a notification request for the communication path information with respect to the information terminal, and may receive the communication path information from the information terminal in response to the notification request.

In the above-described way, it is possible to make a request for communication path information from the wearable apparatus side.

In the aspect of the invention, the control unit may perform the process of making the notification request at a transfer timing for the transfer data.

In the above-described way, it is possible to make a request for communication path information at an appropriate timing.

In the aspect of the invention, the transfer data may be measured data which is measured by a sensor.

In the above-described way, it is possible to transfer measured data via an appropriate communication path,

In the aspect of the invention, in a case where the communication path information indicating that connection using the Wi-Fi communication is possible is received by the second communication unit, the control unit may select transfer of the transfer data using the Wi-Fi communication, and the first communication unit may transfer the transfer data through the Wi-Fi communication.

In the above-described way, it is possible to select an appropriate communication path according to a connection situation of Wi-Fi communication.

In the aspect of the invention, the information terminal may be a terminal which can perform mobile communication, and, in a case where the communication path information indicating that connection using the mobile communication is possible is received by the second communication unit, the control unit may select transfer of the transfer data using the Bluetooth communication in order to transfer data through the mobile communication in the information terminal, and the second communication unit may transfer the transfer data to the information terminal through the Bluetooth communication.

In the above-described way, it is possible to select an appropriate communication path according to a connection situation of mobile communication.

In the aspect of the invention, in a case where the communication path information indicating that connection not possible by using either the Wi-Fi communication or the mobile communication is received by the second communication unit, the control unit may select transfer of the transfer data using the Bluetooth communication in order to accumulate the transfer data in the information terminal, and the second communication unit may transfer the transfer data to the information terminal through the Bluetooth communication.

In the above-described way, it is possible to select a communication path via which transfer data is accumulated in the information terminal.

In the aspect of the invention, in a case where the communication path information indicating that the Wi-Fi communication is possible is received by the second communication unit in a state in which the transfer data is transferred to the information terminal through the Bluetooth communication, the control unit may perform control of stopping transfer of the transfer data using the Bluetooth communication and starting transfer of the transfer data using the communication.

In the above-described way, it is possible to transfer data at a high speed by prioritizing Wi-Fi communication.

In the aspect of the invention, even in a case where the communication path information indicating that connection using the Wi-Fi communication is possible is received by the second communication unit, the control unit may select transfer of the transfer data using the Bluetooth communication on the basis of state information of the wearable apparatus, and the second communication unit may transfer the transfer data to the information terminal through the Bluetooth communication.

In the above-described way, it is possible to lower the priority of Wi-Fi communication depending on a state of the wearable apparatus.

In the aspect of the invention, the state information of the wearable apparatus may include at least one of power information of the wearable apparatus and data amount information of the transfer data which is a transfer target of the wearable apparatus.

In the above-described way, it is possible to take into consideration at least one of power and an amount of transfer data as a state of the wearable apparatus.

Another aspect of the invention relates to an information terminal including a first communication unit that performs Wi-Fi communication with a gateway apparatus; a second communication unit that performs Bluetooth communication with a wearable apparatus which can perform the Wi-Fi communication with the gateway apparatus; and a control unit that performs communication control on the first communication unit and the second communication unit, in which the control unit generates communication path information for setting a communication path which is used for transfer of transfer data in the wearable apparatus on the basis of a search result of the gateway apparatus in the first communication unit, and the second communication unit transmits the communication path information to the wearable apparatus through the Bluetooth communication.

In the aspect of the invention, the information terminal searches for a gateway apparatus with the first communication unit, and transmits communication path information based on a search result to the wearable apparatus through Bluetooth communication. In the above-described way, in a case of using the wearable apparatus which can perform Wi-Fi communication, the information terminal side can perform a determination of the connectability using at least the Wi-Fi communication (search for a gateway apparatus), and thus it is possible to implement an information terminal which can efficiently cooperate with the wearable apparatus.

In the aspect of the invention, the information terminal may further include a third communication unit that performs mobile communication, the second communication, unit may receive the transfer data from the wearable apparatus through the Bluetooth communication, and the third communication unit may transfer the transfer data through the mobile communication.

In the above-described way, it is possible to perform transfer of transfer data from the wearable apparatus via the information terminal by using Bluetooth communication and mobile communication.

Another aspect of the invention relates to a communication system including any one of the wearable apparatuses; and the information terminal.

Another aspect of the invention relates to an electronic apparatus including a first communication unit that performs communication with a gateway apparatus according to a first wireless communication method; a second communication unit that performs communication with an information terminal which can perform communication with the gateway apparatus according to the first wireless communication method, according to a second wireless communication method which is different from the first wireless communication method; and, a control unit that performs communication control on the first communication unit and the second communication unit, in which the second communication unit receives communication path information from the information terminal according to the second wireless communication method, and in which the control unit performs control of selecting either one of the first wireless communication method and the second wireless communication method on the basis of the communication path information, and transferring transfer data.

In the aspect of the invention, the electronic apparatus which can perform communication based on the first and second wireless communication methods receives communication path information from the information terminal according to the second wireless communication method, and selects either one of the first and second wireless communication methods on the basis of the communication path information. In the above-described way, some processes which are required to select a communication path can be performed by the information terminal, and thus it is possible to reduce power consumption in the electronic apparatus and also to select an appropriate communication path.

In the aspect of the invention, the second wireless communication method may be ad hoc communication between the information terminal and the electronic apparatus.

In the above-described way, it is possible to use a communication method not using a gateway apparatus between the information terminal and the electronic apparatus, as the second wireless communication method.

Another aspect of the invention relates to a communication control method for a wearable apparatus including a first communication unit that performs Wi-Fi communication with a gateway apparatus, and a second communication unit that performs Bluetooth communication with an information terminal which can perform the Wi-Fi communication with the gateway apparatus, through Bluetooth communication, the method including receiving communication path information from the information terminal via the second communication unit through the Bluetooth communication; and performing control of selecting either one of the Wi-Fi communication and the Bluetooth communication on the basis of the received communication path information, and transferring transfer data.

### BRIEF DESCRIPTION OF THE DRAWINGS

The invention will be described with reference to the accompanying drawings, wherein like numbers reference like elements.

FIG. 1 illustrates a configuration example of a wearable apparatus (electronic apparatus).

FIG. 2 illustrates an exterior example of the wearable apparatus.

FIG. 3 illustrates an exterior example of the wearable apparatus.

FIG. 4 illustrates a configuration example of a communication system.

FIG. 5 is a sequence diagram for explaining a process in the present embodiment.

FIG. 6 is a sequence diagram for explaining a process in the present embodiment.

FIG. 7 illustrates specific examples of the connectability using Wi-Fi communication and mobile communication, and communication paths.

FIG. 8 illustrates specific examples of the connectability using Wi-Fi communication and mobile communication, and communication paths.

FIG. 9 illustrates specific examples of the connectability using Wi-Fi communication and mobile communication, and communication paths.

FIG. 10 illustrates specific examples of the connectability using Wi-Fi communication and mobile communication, and communication paths.

FIG. 11 illustrates an example of selecting a communication path on the basis of state information of the wearable apparatus.

### DESCRIPTION OF EXEMPLARY EMBODIMENTS

Hereinafter, the present embodiment will be described. The embodiments described below are not intended to improperly limit the content of the invention disclosed in the appended claims. In addition, all constituent elements described below are not essential constituent elements of the invention.

### 1. TECHNIQUE OF PRESENT EMBODIMENT

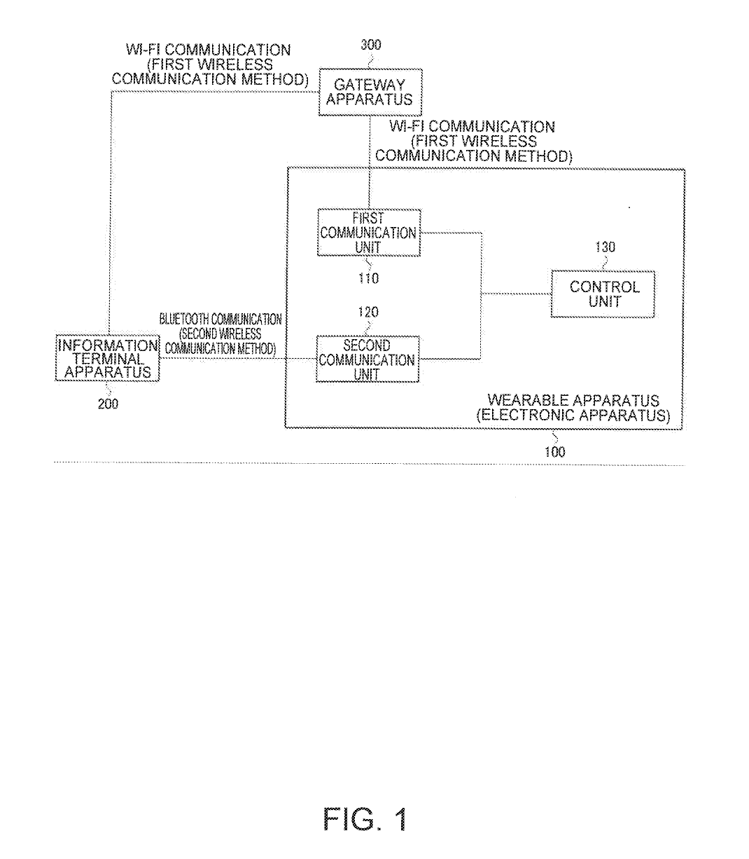

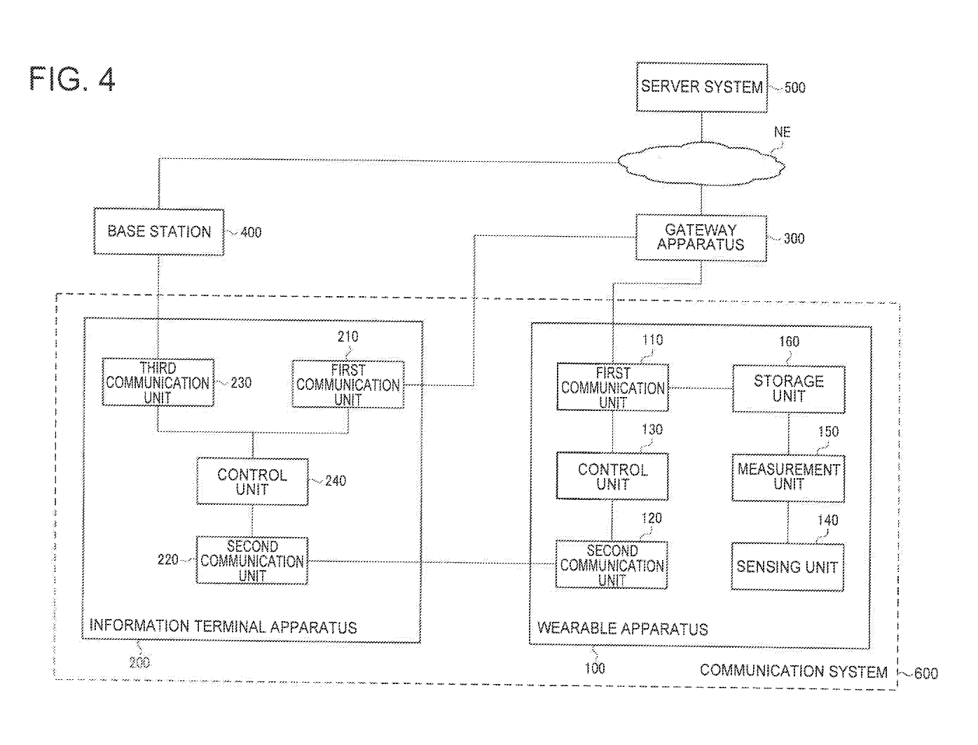

First, a description will be made of a technique of the present embodiment. In recent years, a wearable apparatus 100 (a configuration thereof will be described later with reference to FIG. 1) which can use both of Wi-Fi communication and Bluetooth communication has been widely spread. In the wearable apparatus 100, it is expected that transfer data is transferred to other apparatuses (for example, a server system 500 in FIG. 4) through wireless communication using a network.

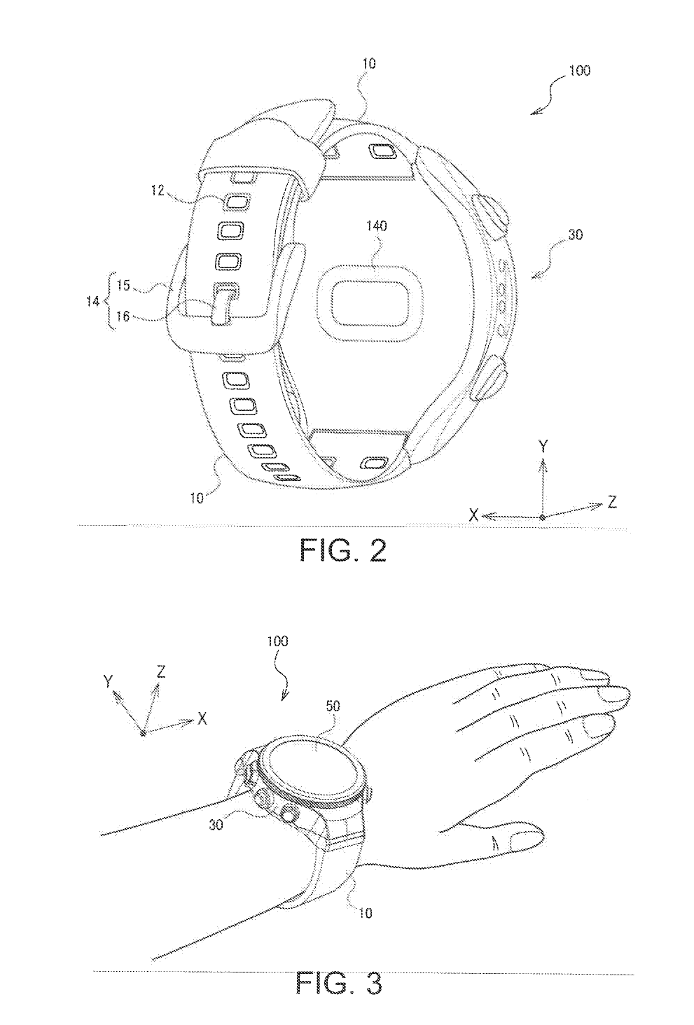

For example, as will be described later with reference to FIG. 2 or the like, in a case where the wearable apparatus 100 is an activity amount meter (in a narrow sense, a biological information detection apparatus), the wearable apparatus 100 measures activity amount information (biological information) of a user, and transfers (transmits) the measured activity amount information to the server system 500 as transfer data (transmission data). The server system 500 accumulates activity amount information and performs processes (a statistical process, an analysis process, and the like) based on the accumulated activity amount information.

Alternatively, in a case where firmware of the wearable apparatus 100 is updated, the wearable apparatus 100 transfers (receives) the firmware from the server system 500 as transfer data (reception data).

In a case where Wi-Fi communication is compared with tooth communication, Wi-Fi communication is more advantageous in terms of a communication speed. Therefore, the wearable apparatus 100 preferably use Wi-Fi communication when transfer data is transferred.

However, typically, in a case where a connection process is performed by using Wi-Fi, it is necessary to perform procedures in which the wearable apparatus 100 searches for whether of not a Wi-Fi apparatus (gateway apparatus 300) as a connection target is in a connectable state (within a connectable range), and then performs connection. Large power consumption is required to search for whether or not the gateway apparatus as a connection target is connectable at the present time, and thus the wearable apparatus 100 which is driven with a restricted battens capacity cannot search for the peripheral gateway apparatus 300 at all times.

Therefore, in the technique of the related art, only in a case where a user presses a “connection” button, or communication target transfer data (metadata or the like) is created and thus communication is necessary, search is performed so that power consumption is reduced.

However, in Wi-Fi communication, it is preferable that Wi-Fi connection is automatically established without a user's awareness in a case where a situation occurs in which Wi-Fi communication is available (for example, a user returns to the user's home or moves to the vicinity of a free spot). For example, in a portable terminal such as a smart phone, it is a natural form that Wi-Fi function is normally turned on, Wi-Fi communication is automatically selected if Wi-Fi is available, and mobile communication (3G, 4G, or the like) is automatically selected if Wi-Fi is unavailable. In other words, from the user side, it is a troublesome procedure to press the “connection” button, and thus there is the demand for automatic upload using Wi-Fi without performing such a procedure.

In a case where a situation occurs in which Wi-Fi is available in a situation in which transfer data as a communication target is created so that communication is necessary, search and communication can be automatically started without the need of a user's operation. However, particularly, there are few cases where Wi-Fi is normally available in outdoor environments in which a wearable apparatus or the like is mainly used. As a result, a user is required to determine whether or not a wearable apparatus is in a connectable Wi-Fi environment (for example, whether or not the user is in the user's home), and to press the “connection” button.

In the above description, a description has been made of searching for a Wi-Fi apparatus (gateway apparatus 300), but power consumption of data transfer is also larger in Wi-Fi communication than in Bluetooth communication or the like. Thus, if the chance to use Wi-Fi is prioritized, there is a problem in that an operation time of the wearable apparatus 100 is extremely reduced.

In light of the above-described content, in the present embodiment, at least a part of determination of a connection situation (communication path selection process) is performed by an information terminal 200 which is different from the wearable apparatus 100.

Specifically, as illustrated in FIG. 1, the wearable apparatus 100 of the present embodiment includes a first communication unit 110 (first communication device) performing Wi-Fi communication with the gateway apparatus 300; a second communication unit 120 (second communication device) performing Bluetooth communication with the information terminal 200 which can perform Wi-Fi communication with the gateway apparatus 300; and a control unit 130 (a processor or a controller) performing communication control on the first communication unit 110 and the second communication unit 120.

The second communication unit 120 receives communication path information from the information terminal 200 through Bluetooth communication, and the control unit 130 performs control of selecting either one of Wi-Fi communication and Bluetooth communication on the basis of the communication path information, and transferring transfer data.

Wi-Fi communication here is communication which is already standardized in, for example, IEEE 802.11, but is not limited thereto, and may include advanced standards thereof. Bluetooth communication is not limited to BLE, and includes communication based on other Bluetooth standards and advanced standards thereof.

The communication path information is information for determining a communication path, that is, information for determines whether the wearable apparatus 100 transfers transfer data through Wi-Fi communication or Bluetooth communication. The communication path information may be information regarding whether or not the information terminal 200 can perform Wi-Fi communication, that is, information regarding whether or not there is the available gateway apparatus 300 is present in the vicinity of the information terminal 200. In a case where the information terminal 200 is an apparatus which can use mobile communication (cellular network communication, 3G, or 4G), the communication path information may include information regarding whether or not the information terminal 200 can perform mobile communication, that is, information regarding whether or not an available base station 400 is present in the vicinity of the information terminal 200.

Alternatively, in a case where the information terminal 200 determines a communication path, the communication path information may be information indicating a determination result. The communication path information in this case may be, for example, information for instructing the wearable apparatus 100 to select Wi-Fi communication or information for instructing the wearable apparatus 100 to select Bluetooth communication.

in the above-described way, control unit 130 of the wearable apparatus 100 can use information from the information terminal 200 for selection of use of either Wi-Fi communication or Bluetooth communication when transfer data is transferred, in the technique of the present embodiment, the information terminal 200 can perform search for the gateway apparatus 300 in communication, and thus power consumption due to search can be reduced in the wearable apparatus 100. In other words, in the wearable apparatus 100, search for the gateway apparatus 300 is preferably performed only in a case where a probability that Wi-Fi communication can be performed is considerably high, and thus it is possible to reduce power consumption due to unnecessary search.

In this case, Bluetooth communication is used for transmission and reception of communication path information. The wearable apparatus 100 and the information terminal 200 are expected to be used at a short distance. In Bluetooth communication, power consumption is smaller than in Wi-Fi communication, and there are few problems even if normal connection is performed. In other words, Bluetooth communication between the wearable apparatus 100 and the information terminal 200 may be normally available, and necessary information can be appropriately transmitted and received.

In a case where the technique of the present embodiment is realized, preferably, a condition is satisfied in which, if the information terminal 200 can perform Wi-Fi communication, the wearable apparatus 100 can also perform Wi-Fi communication. This can be realized by using the gateway apparatus 300 which can be connected to the information terminal 200 and the gateway apparatus 300 which can be connected to the wearable apparatus 100 in common. More specifically, authentication information of communication may be shared, and, in a narrow sense, authentication information may be transmitted from the information terminal 200 to the wearable apparatus 100. A specific method will be described later.

In the above description, a description has been made of the wearable apparatus 100 which can use Wi-Fi communication and Bluetooth communication as wireless communication methods. However, the technique of the present embodiment may be extendable to an apparatus which can use a plurality of wireless communication methods having different characteristics.

Specifically, the technique of the present embodiment is applicable to an electronic apparatus including a first communication unit which performs communication with a gateway apparatus according to a first wireless communication method; a second communication unit which performs communication with an information terminal which can perform communication with the gateway apparatus according to the first wireless communication method, according to a second wireless communication method which is different from the first wireless communication method; and a control unit which performs communication control on the first communication unit and the second communication unit. The second communication unit of the electronic apparatus receives communication path information from the information terminal according to the second wireless communication method, and the control unit performs control of selecting either one of the first wireless communication method and the second wireless communication method on e basis of the communication path information, and transferring transfer data.

Here, the second wireless communication method is ad hoc communication between the information terminal and the electronic apparatus. The second wireless communication method is, for example, Bluetooth communication, but is not limited thereto. For example, the second wireless communication method may be near field radio communication (NFC), ANT+, or advanced standards thereof.

The first wireless communication method is not limited to Wi-Fi communication. For example, the first wireless communication method may be Wireless Smart Utility Network (Wi-SUN), an Ultra Wide Ban (UWB) wireless system, or advanced standards thereof.

Hereinafter, mobile communication will be described as a communication method which is different from both of Wi-Fi communication first wireless communication method) and Bluetooth communication (second wireless communication method), but the mobile communication may be extendable to a third wireless communication method.

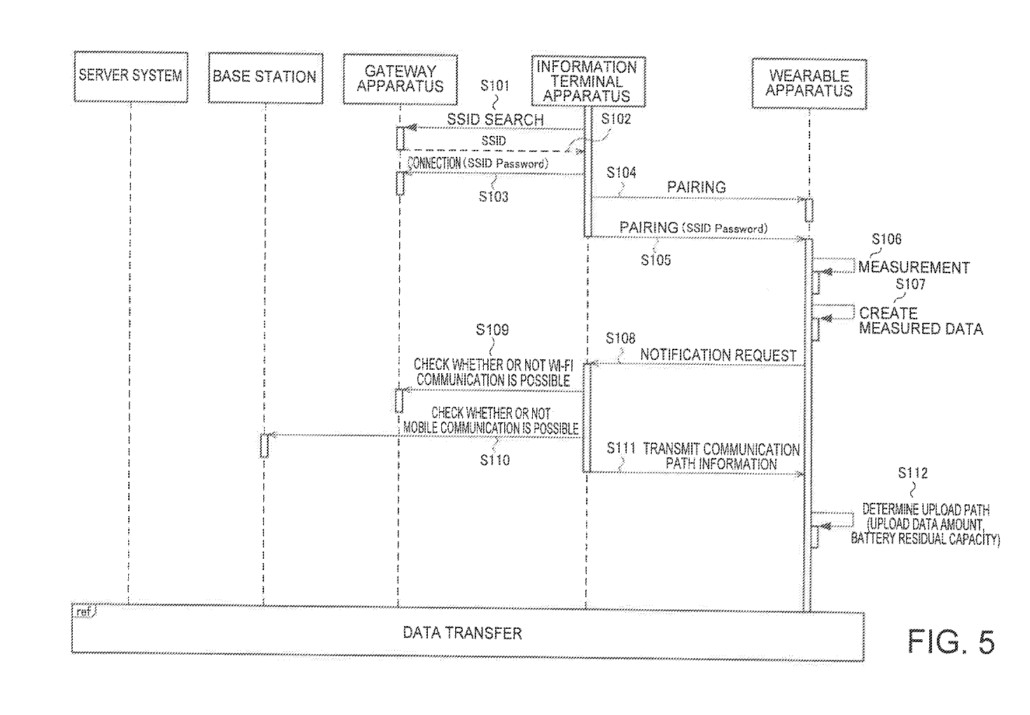

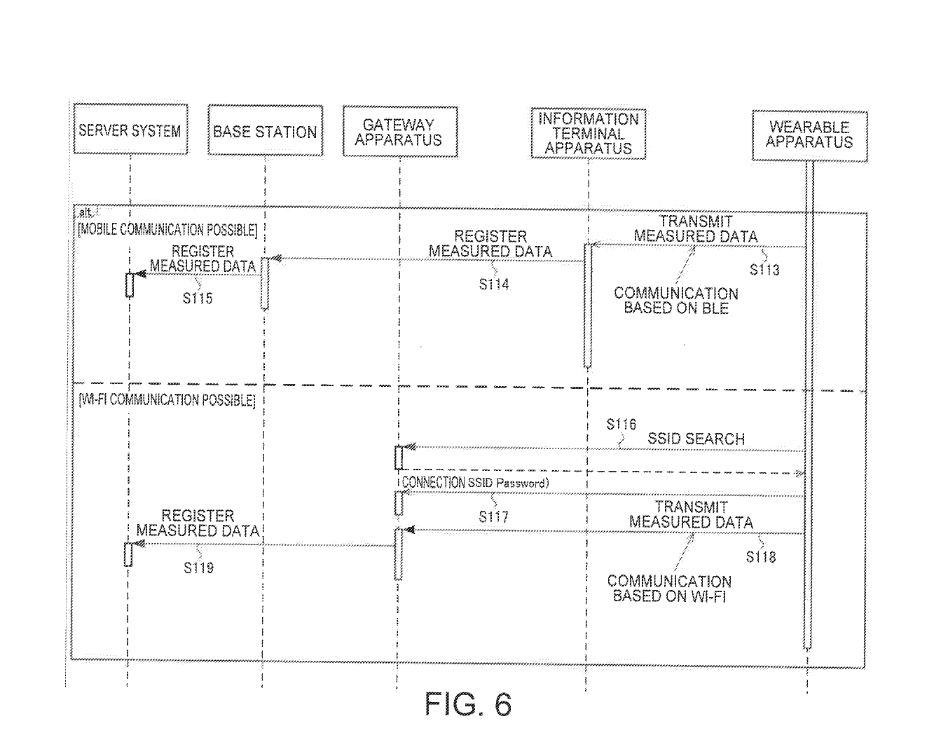

Hereinafter, configuration examples of the wearable apparatus 100 of the present embodiment and a communication system 600 will be described, and then an example of specific communication control will be described with reference to sequence diagrams of FIGS. 5 and 6. Finally, several modification examples will be described. Hereinafter, a description is made of an example in which the first wireless communication method is Wi-Fi communication, the second wireless communication method is the Bluetooth communication (BLE), and the electronic apparatus is the wearable apparatus 100, but these are extendable as described above.

### 2. SYSTEM CONFIGURATION EXAMPLE

A configuration example of the wearable apparatus 100 is as illustrated in FIG. 1. The wearable apparatus 100 includes the first communication unit 110, the second communication unit 120, and the control unit 130. As illustrated in FIG. 4, the wearable apparatus 100 may include a sensing unit 140, a measurement unit 150, and a storage unit 160. However, a configuration of the wearable apparatus 100 is not limited to the configurations illustrated in FIGS. 1 and 4, and may be variously :cleaned, for example, some of the constituent elements may be omitted, or other constituent elements may be added thereto. For example, as will be described later with reference to FIG. 3, the wearable apparatus 100 may include a display unit 50.

The first communication unit 110 (a first communication device or a first communication circuit) performs Wi-Fi communication (in a broad sense, communication using the first wireless communication method) with the gateway apparatus 300. The first communication unit 110 may be implemented by, for example, a wireless communication module including an antenna for Wi-Fi, and a processing circuit which performs processing for a high frequency signal according to a protocol of Wi-Fi communication.

The second communication unit 120 (a second communication device or a second communication circuit) performs Bluetooth communication (in a broad sense, communication using the second wireless communication method) with the information terminal 200. The second communication unit 120 may be implemented by, for example, a Bluetooth module including an antenna for Bluetooth, and a processing circuit which performs processing for a high frequency signal according to a protocol of Bluetooth.

The control unit 130 performs communication control on the first communication unit 110 and the second communication unit 120. Functions of the control unit 130 may be realized by various processors such as a central processing unit (CPU), hardware such as an application specific integrated circuit (ASIC) or a gate array, programs, or the like. The control unit 130 performs control of selecting either one of Wi-Fi communication and Bluetooth communication (selecting either one of the first communication unit 110 and the second communication unit 120) on the basis of the communication path information acquired from the information terminal 200 via the second communication unit 120, and transferring transfer data. Although control becomes complex, both of the first communication unit 110 and the second communication unit 120 may be used to transfer predetermined transfer data.

The control unit 130 may determine a communication path information request timing, a transfer data transfer starting timing, or the like.

The sensing unit 140 (a sensor or a sensor module) senses various pieces of information. The sensing unit 140 includes, for example, a body motion sensor or a living body sensor. The body motion sensor may be implemented by an acceleration sensor, a gyro sensor, an atmospheric pressure sensor, a geomagnetic sensor, or a position sensor such as a global positioning system (GPS) receiver. The living body sensor may be implemented by a pulse wave sensor, an arterial blood oxygen saturation sensor, a temperature sensor, or the like. The sensing unit 140 may include both of the body motion sensor and the living body sensor, and may include either one thereof. The body motion sensor and the living body sensor may be any one of the above-described sensors, and may be a combination of a plurality of sensors. The sensing unit 140 may include sensor other than the body motion sensor and the living body sensor. For example, an environment sensor which senses a surrounding environment may be included.

The measurement unit 150 (a measurement circuit or a processor) performs operation control for the sensing unit 140, or performs signal processing or the like based on a sensor signal from the sensing unit 140. Functions of the measurement unit 150 may be realized by a CPU or the like, and the control unit 130 may serve as the measurement unit 150. The measurement unit 150 acquires body motion information on the basis of sensor information from, for example, the body motion sensor. The body motion information may be acceleration information, angular velocity information, or the like, and may be position information of a user obtained on the basis of the information. The measurement unit 150 acquires biological information on the basis of sensor information from the living body sensor. The biological information is, for example, pulse wave information (a pulse rate, a pulse interval, or a change therein). Hereinafter, data measured by the measurement unit. 150 will be referred to as measured data.

The storage unit 160 (memory) is a work region of the control unit 130, the measurement unit 150, and the like, and functions thereof may be realized by a memory such as a random access memory (RAM), or a hard disk drive (HDD). The storage unit 160 stores measured data obtained in the measurement unit 150.

FIG. 2 illustrates an example of an exterior of the wearable apparatus 100. As illustrated in FIG. 3, the wearable apparatus 100 includes a case portion 30 and a band portion 10 for fixing the case portion 30 to a user's body (in a narrow sense, the wrist), and the band portion 10 is provided with fitting holes 12 and a buckle 14. The buckle 14 is formed of a buckle frame 15 and an engagement part (protrusion rod) 16.

FIG. 2 is a perspective view in which the wearable apparatus 100 in a state in which the band portion 10 is fixed by using the fitting holes 12 and the engagement part 16 is viewed from a direction (among surfaces of the case portion 30, a surface side as a subject side in a mounting state) of the band portion 10 side. In the wearable apparatus 100 in FIG. 2, the band portion 10 is provided with a plurality of fitting holes 12, and the engagement part 16 of the buckle 14 is inserted into any one of the plurality of fitting holes 12 so that the wearable apparatus 100 is mounted on a user. As illustrated in FIG. 2, the plurality of fitting holes 12 are provided along a longitudinal direction of the band portion 10.

The case portion 30 of the wearable apparatus 100 is provided with a sensor unit (sensing unit 140). FIG. 2 illustrates an example in which a wing body sensor (particularly, pulse wave sensor) is assumed, and the sensor unit is provided on the surface serving as a subject side in the case portion 30 when the wearable apparatus 100 is mounted. However, a position where a sensor included in the sensor unit is provided is not limited to the position in FIG. 2. For example, the body motion sensor may be provided inside the case portion 30 (particularly, on a sensor board included in the case portion 30).

FIG. 3 is a view in which the wearable apparatus 100 mounted on the user is viewed from the side where the display unit 50 is provided. As can be seen from FIG. 3, the wearable apparatus 100 according to the present embodiment has the display unit 50 at a position corresponding to a dial of a typical wristwatch, or a position where numbers or icons can be visually recognized. In a mounting state of the wearable apparatus 100, the surface on the side illustrated in FIG. 2 in the case portion 30 comes into close contact with the subject, and the display unit 50 is located to be easily visually recognized by the user.

In FIGS. 2 and 3, a coordinate system is set with the ease portion 30 of the wearable apparatus 100 as a reference, and a direction which intersects a display surface of the display unit 50 and is directed from a rear surface toward a front surface when the display surface side of the display unit 50 is the front surface is set as a positive Z axis direction. Alternatively, a direction directed from the sensor unit (in a narrow sense, the pulse wave sensor illustrated in FIG. 2) toward the display unit 50, or a direction of becoming distant from the case portion 30 in a normal direction of the display surface of the display unit 50 may be set as a positive Z axis direction. The positive Z axis direction corresponds to a direction directed from a subject toward the case portion 30 in a state in which the wearable apparatus 100 is mounted on the subject. Two axes which are orthogonal to the Z axis are respectively set as an X axis and a Y axis, and, particularly, a direction in which the band portion 10 is attached to the case portion 30 is set as the Y axis direction.

In FIGS. 2 and 3, a description has been made of an example of an apparatus held on a user's arm (wrist) via the band portion 10 as the wearable apparatus 100. However, a shape or a mounting location of the wearable apparatus 100 is not limited thereto. For example, the wearable apparatus 100 may be an apparatus which mounted on other parts of a user, such as the ankle, via the band portion 10, and may be a head mounted display (HMD).

The technique of the present embodiment is not limited to being applied to the wearable apparatus 100. The technique of the present embodiment is applicable to a communication system 600 including the wearable apparatus 100 and the information terminal 200.

FIG. 4 illustrates a configuration example of the communication system 600 including the wearable apparatus 100 of the present embodiment. A configuration of the wearable apparatus 100 is the same as described above.

The information terminal 200 includes a first communication unit 210 (first communication device), a second communication unit 220 (second communication device), a third communication unit 230 (third communication device), and a control unit 240 (processor). The first communication unit 210 performs Wi-Fi communication via the gateway apparatus 300. The second communication unit 220 performs Bluetooth communication with the second communication unit 120 of the wearable apparatus 100. The third communication unit 230 performs mobile communication via the base station 400.

The control unit 240 performs communication control on the first communication unit 210, the second communication unit 220, and the third communication unit 230. The control unit 240 performs a process of acquiring information regarding a connection situation of the first communication unit 210 and a connection situation of the third communication unit 230 and generating communication path information. The control unit 240 may generate information regarding the connectability of each communication unit as communication path information. Alternatively, the control unit 240 may select a communication path of the wearable apparatus 100 on the basis of the connectability, and may use information indicating the selected communication path as communication path information. Specific examples of communication paths will be described later.

The information terminal 200 is assumed to be a small and lightweight apparatus which is carried by a user, and is, for example, a smart phone. However, the information terminal 200 may be configured not to perform mobile communication (not to include the third communication unit 230), and the information terminal 200 in this case may be implemented by various apparatuses which can perform Wi-Fi communication and Bluetooth communication.

As illustrated in FIG. 4, the wearable apparatus 100 and the information terminal 200 can transfer data with the server system 500 through Wi-Fi communication in a case where the gateway apparatus 300 is within a connectable range. The information terminal 200 can transfer data with the server system 500 through mobile communication in a case where the base station 400 is within a connectable range. A network NE in FIG. 4 may include a mobile communication network, a public network such as the Internet, a fixed telephone network, or the like.

The wearable apparatus 100 and the information terminal 200 can be connected to each other through Bluetooth communication. In order to perform connection using Bluetooth communication, the wearable apparatus 100 and the information terminal 200 are required to be close to each other to some extent. A specific communicable distance is several m to several tens of m in Bluetooth communication of the related art, but, in recent years, a standard in which communication can be performed even at a distance of about 100 m has been proposed.

In the present embodiment, the wearable apparatus 100 is mounted on a user, and the information terminal 200 is carried by the user, and thus it is assumed that the distance between the wearable apparatus 100 and the information terminal 200 are maintained at a short distance so that Bluetooth communication can be performed. In Bluetooth communication, power consumption is smaller than in Wi-Fi communication, and there are few problems even if normal connection is performed. Therefore, it is assumed that data transfer between the second communication unit 120 of the wearable apparatus 100 and the second communication unit 220 of the information terminal 200 is available at all time.

The technique of the present embodiment is applicable to the information terminal 200. Specifically, the technique of the present embodiment is applicable to the information terminal 200 including the first communication unit 210 which performs Wi-Fi communication with the gateway apparatus 300; the second communication unit 220 which performs Bluetooth communication with the wearable apparatus 100 which can perform Wi-Fi communication with the gateway apparatus 300; and the control unit 240 which performs communication control on the first communication unit 210 and the second communication unit 220. The control unit 240 of the information terminal 200 generates communication path information for setting a communication path used for transfer of transfer data in the wearable apparatus 100 on the basis of a search result of the gateway apparatus 300 in the first communication unit 210, and the second communication unit 220 transmits the communication path information to the wearable apparatus through Bluetooth communication.

The information terminal 200 may further include the third communication unit 230 which performs mobile communication. The second communication unit 220 of the information terminal 200 receives the transfer data from the wearable apparatus 100 through Bluetooth communication, and the third communication unit 230 transfers the transfer data through mobile communication. This case, the transfer of the transfer data in the wearable apparatus 100 is transmission of the transfer data (measured data) from the wearable apparatus 100 to an apparatus such as the server system 500.

In the wearable apparatus 100 and the information terminal 200 of the present embodiment, some or most of the processes therein may be performed according to a program. In this case, a processor such as a CPU executes the program, and thus the wearable apparatus 100 or the like of the present embodiment is implemented. Specifically, a program stored in a non-transitory information storage device is read, and a processor such as a CPU executes the read program. Here, the information storage device (a computer readable device or medium) stores programs or data, and a function thereof may be realized by an optical disc (a DVD, a CD, or the like), a hard disk drive (HDD), a memory (a card type memory, a ROM, or the like), or the like. The processor such as a CPU performs various processes in the present embodiment on the basis of the program (data) stored in the information storage device. In other words, the information storage device stores a program (a program causing a computer to perform a process in each unit) causing the computer (an apparatus including an operation unit, a processing unit, a storage unit, and an output unit) to function as each unit of the present embodiment.

The wearable apparatus 100 or the like of the present embodiment may include a processor and a memory. A function of each unit of the processor here may be realized in individual hardware, or may be realized in integrated hardware. For example, the processor may include hardware, and the hardware may include at least one of a circuit processing a digital signal and a circuit processing an analog signal. For example, the processor may be formed of one or a plurality of circuit devices (for example, ICs) mounted on a circuit board, or one or a plurality of circuit elements (for example, resistors and capacitors). The processor may be, for example, a central processing unit (CPU). However, the processor is not limited to a CPU, and may employ various processors such as a graphics processing unit (GPU) or a digital signal processor (DSP). The processor may be a hardware circuit using an ASIC. The processor may include, for example, an amplification circuit or a filter circuit processing an analog signal. The memory may be a semiconductor memory such as an SRAM or a DRAM, may be a register, maybe a magnetic storage device such as a hard disk device, and may be an optical storage device such as an optical disc device. For example, the memory stores computer readable commands, and the commands are executed by the processor so that a function of each unit of the wearable apparatus 100 or the like is realized. The commands here may be commands in a command set forming a program, and may be commands for instructing a hardware circuit of the processor to perform an operation.

### 3. SPECIFIC EXAMPLE OF COMMUNICATION CONTROL

FIGS. 5 and 6 are sequence diagrams for explaining communication control of the present embodiment. In technique of the present embodiment, preparation for Wi-Fi communication is made as a pre-stage of performing data transfer in the wearable apparatus 100 (steps S101 to S105).

Specifically, the first communication unit 210 of the information terminal 200 searches for a service set identifier (SSID; including an extended standard) of the peripheral gateway apparatus 300 (step S101), and acquires the SSID from the gateway apparatus 200 within a communicable range (step S102). Step 5102 is performed by, for example, receiving a broadcast message with the SSID.

In a case where an SSID of the gateway apparatus 300 which is a connection target of the information terminal 200, that is, the gateway apparatus 300 for which a password is known has been retrieved, the information terminal 200 performs connection to the gateway apparatus 300 by using the SSID and the password (step S103). Through the processes in steps S101 to S103, a set of the SSID and the password which are valid (which can be actually used for connection to the gateway apparatus 300) can be determined. The information terminal 200 may hold a plurality of valid sets of SSIDs and passwords.

Pairing for performing Bluetooth communication is performed between the wearable apparatus 100 and the information terminal 200 (step S104). This is performed, for example, when a user purchases the wearable apparatus 100 and starts to use the wearable apparatus 100.

After pairing is performed, the wearable apparatus 100 and the information terminal 200 can perform Bluetooth communication at any timing. Therefore, the second communication unit 120 of the wearable apparatus 100 receives authentication information used for an authentication process in the gateway apparatus 300 in Wi-Fi communication (first wireless communication method) through Bluetooth communication (second wireless communication method) (step S105). The authentication information here includes the SSID and the password corresponding to the gateway apparatus 300.

In the above-described way, the wearable apparatus 100 and the information terminal 200 can share the valid authentication information (the SSID and the password) which can be used for connection to the gateway apparatus 300. If the authentication information shared, there is a considerably high probability that the wearable apparatus 100 can also perform Wi-Fi communication in a case where the information terminal 200 can perform Wi-Fi communication. This is because, if Wi-Fi communication can be performed by the information terminal 200, the gateway apparatus 300 which is connectable on the basis of the known authentication information is present on the periphery, the wearable apparatus 100 is considered to be able to be connected to the gateway apparatus 300 by using the same authentication information. In other words, the information terminal 200 can perform determination of whether or not the wearable apparatus 100 can perform Wi-Fi communication.

If authentication information is shared, a user may operate a certain operation part so as to input the authentication information to the wearable apparatus 100. However, since the wearable apparatus 100 is preferably a small-sized apparatus, as illustrated in the example in FIG. 2 or FIG. 3, the number or arrangement of operation parts is restricted, and thus it is not easy to input an SSID or a password. In relation to this fact, as shown in step S105, if the authentication information is transferred through Bluetooth communication, it is possible to reduce a user's burden when the authentication information is shared.

The wearable apparatus 100 may receive authentication information at various timings. For example, the second communication unit 120 of the wearable apparatus 100 may receive authentication information during pairing of Bluetooth communication with the information terminal 200.

In the above-described way, the wearable apparatus 100 and the information terminal 200 can share authentication information when the apparatuses start operations in conjunction with each other. Thus, a period of time for which the information terminal 200 and the wearable apparatus 100 do not share authentication information can be reduced. In a case where authentication information is not shared, there is concern that one of the information terminal 200 and the wearable apparatus 100 can perform Wi-Fi communication, and the other thereof cannot perform Wi-Fi communication, and thus there may be a case where it is not appropriate that the information terminal 200 determines whether or not the wearable apparatus 100 can perform Wi-Fi communication. Thus, reducing a period of time for which authentication information is not shared is useful for effective data transfer.

There may be a case where valid authentication information is newly added in the information terminal 200. For example, there may be a case where a user inputs a new SSID or password, or a case where connection to the gateway apparatus 300 which is not connected hitherto is recognized due to movement of the user.

From the viewpoint of increasing the availability of Wi-Fi communication in the wearable apparatus 100, added authentication information is also preferably shared with the wearable apparatus 100. Therefore, the second communication unit 120 of the wearable apparatus 100 may receive authentication information from the information terminal 200 at a timing which is different from a timing of pairing. As an example, in a case where valid authentication information is added to the information terminal 200, the authentication information is transmitted from the second communication unit 220 of the information terminal 200 to the second communication unit 120 of the wearable apparatus 100.

In the wearable apparatus 100, the sensing unit 140 performs measurement (step S106), the measurement unit 150 creates measured data on the basis of a sensor signal, and the storage unit 160 stores the measured data (step S107).

Transfer data in the present embodiment may be measured data which is measured by a sensor (sensing unit 140). In other words, the wearable apparatus 100 transmits the measured data to an external apparatus (in a narrow sense, the server system 500) via any communication path.

In the present embodiment, as described above, the information terminal 200 determines whether or not Wi-Fi communication can be performed. Therefore, the second communication unit 120 of the wearable apparatus 100 (electronic apparatus) may request the information terminal 200 (second communication unit 220) to send a notification of communication path information (step S108), and may receive the communication path information from the information terminal 200 in response to the notification request (step S111). In the above-described way, the wearable apparatus 100 side can actively make a request for communication path information.

Herein, information regarding whether or not the information terminal 200 can perform Wi-Fi communication and information regarding whether or not the information terminal 200 can perform mobile communication are used as communication path information. Therefore, in a case where the notification request in step S108 is received, the information terminal 200 checks whether or not the first communication unit 210 can perform Wi-Fi communication (step S109), and checks whether or not the third communication unit 230 can perform mobile communication (step S110). The second communication unit 220 transmits check results in steps S109 and S110 to the wearable apparatus 100 (second communication unit 120) as communication path information (step S111).

The control unit 130 of the wearable apparatus 100 makes the notification request, for example, at a transfer timing of transfer data. A timing at which a communication path is to be determined is a case where any data is transferred in the wearable apparatus 100. Therefore, if a transfer timing of transfer data is set as a notification request timing, it is possible to appropriately make a request for necessary communication path information.

As described above, in a case where transfer data is measured data based on a sensor, a transfer timing is a timing at which transmission of the measured data is necessary. More specifically, the transfer timing may be a timing at which measured data reaches a predetermined data amount, a timing at which a predetermined period elapses from the previous transfer timing, or a periodic transmission timing (for example, once an hour) which is set at a predetermined interval. Alternatively, the transfer timing may be a timing at which characteristics of data change, for example, a timing at which measured data is changed from data during resting to data during exercise due to a user changing from a rest state to an exercise state. Specific examples of transfer timings may be variously modified.

The control unit 130 of the wearable apparatus 100 performs control of receiving the communication path information from the information terminal 200 in response to the notification request and then transferring transfer data. Specifically, the control unit 130 determines a communication path on the basis of the received communication path information (step S112). Whether or not each communication is possible changes depending on a situation (for example, a position of a user using the wearable apparatus 100 or the like). Therefore, the process (in a broad sense, the processes in steps S109 to S112) in step S111 is preferably performed for each predetermined period while transfer data is continuously transferred. As a result, there is a case where a selected communication path is changed during transfer of transfer data.

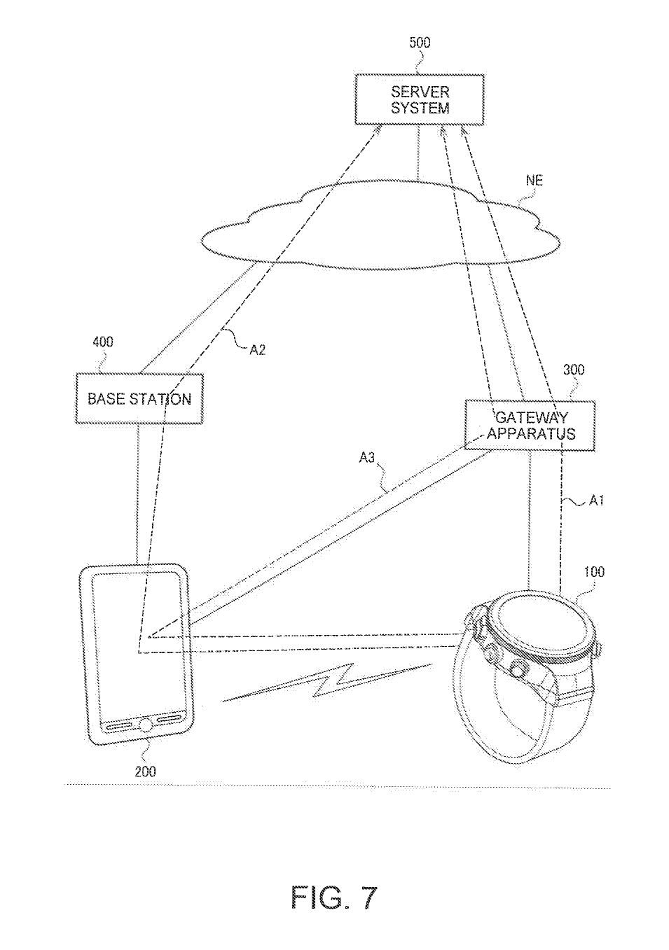

FIGS. 7 to 10 are diagrams for explaining specific examples of a communication state (communication path). As described above, in the present embodiment, it is assumed that Bluetooth communication between the wearable apparatus 100 and the information terminal 200 is available at all times. It may be considered that, by sharing authentication information, Wi-Fi communication is also possible in the wearable apparatus 100 in a case where the information terminal 200 can perform Wi-Fi communication.

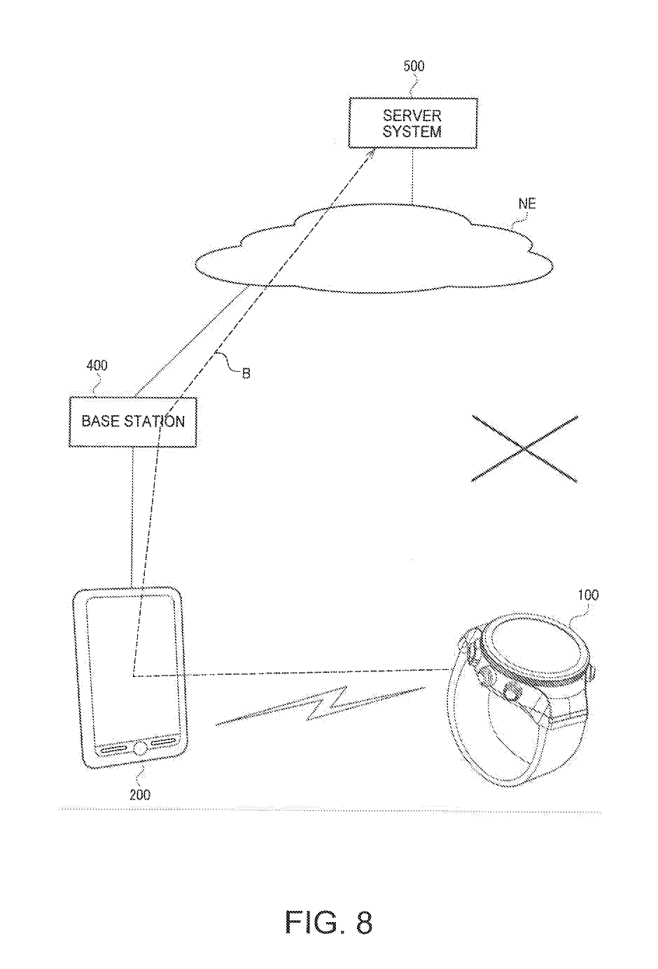

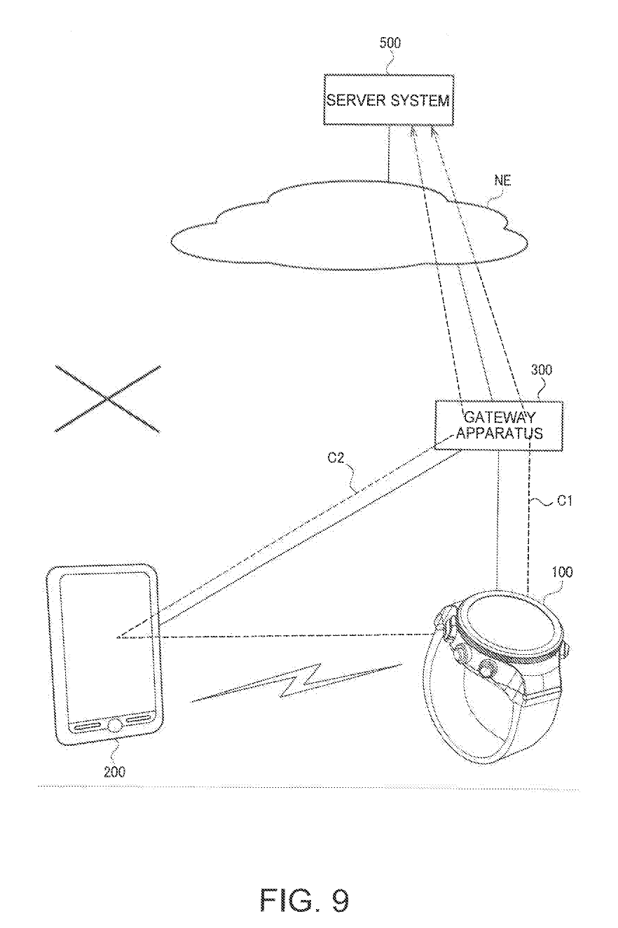

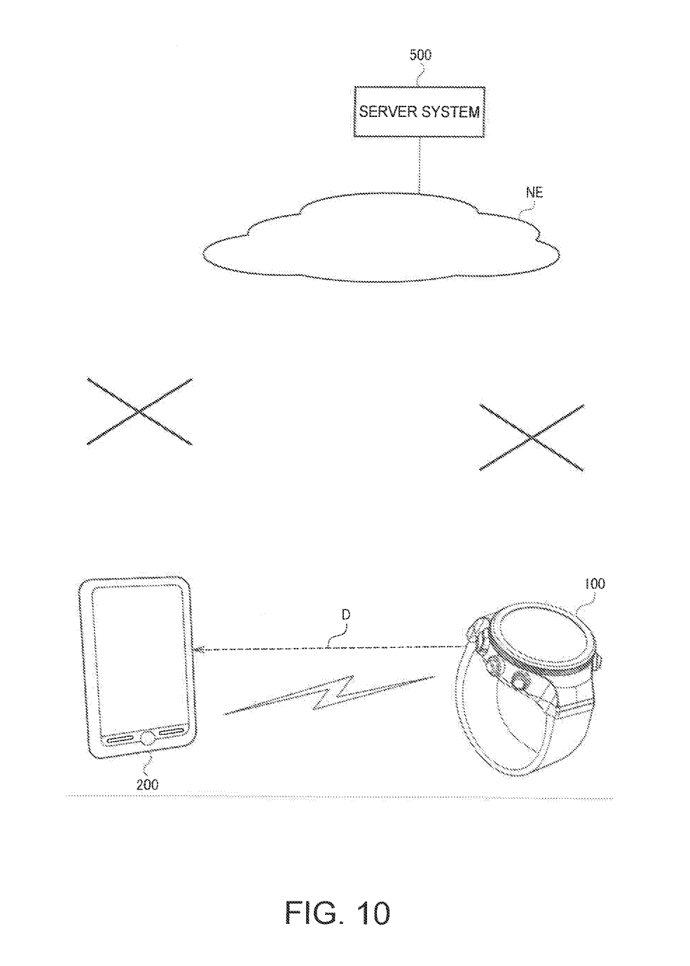

Therefore, specific examples of communication states may include four ways including two ways of whether or not Wi-Fi communication is possible and two ways of whether or not the information terminal 200 can perform mobile communication. FIG. 7 illustrates a case where both of Wi-Fi communication and mobile communication are possible, FIG. 8 illustrates a case where mobile communication is possible but Wi-Fi communication is not possible, FIG. 9 illustrates a case where Wi-Fi communication is possible, but mobile communication is not possible, and FIG. 10 illustrates a case where neither of Wi-Fi communication and mobile communication are possible.

For example, in a case where communication path information indicating that the information terminal 200 can perform mobile communication (in a broad sense, communication in the third wireless communication method), and can be connected through mobile communication is received by the second communication unit 120, the control unit 130 selects transfer of transfer data using Bluetooth communication in order to transfer data through mobile communication in the information terminal 200, and the second communication unit 120 transfers the transfer data to the information terminal 200 through Bluetooth communication.

This mainly corresponds to the case illustrated in FIG. 8. In FIG. 8, since Wi-Fi communication is not possible, the wearable apparatus 100 cannot directly transfer data to the server system 500. Therefore, as shown in FIG. 6 and a path B in FIG. 8, transfer data is temporarily transferred to the information terminal 200 through Bluetooth communication (step S113), and the transfer data is transferred from the information terminal 200 to the server system 500 via the base station 400 through mobile communication (steps S114 and S115).

Mobile communication has a wider available range and higher availability than Wi-Fi communication. In other words, it can be said that there is a high probability that the situation in FIG. 8 may occur more than the situation in FIG. 9. Therefore, in a case where the information terminal 200 can perform mobile communication, the transfer data is transferred to the information terminal 200. In the above-described way, it is possible to secure upload means for transfer data using mobile communication and thus to perform transfer of the transfer data in many cases.

In a case where mobile communication is possible, the control unit 130 may start the processes in steps S113 to S115 without waiting for a determination of whether or not Wi-Fi communication is possible. Generally, a search for the base station 400 using mobile communication requires shorter time than a search for the gateway apparatus 300 using communication. In steps S109 to S111, an example is shown in which both of the search results are collectively transmitted and received as communication path information, but, actually, there are many cases where a search result of mobile communication is first received by the wearable apparatus 100 (second communication unit 120), and then a search result of Wi-Fi communication is received by the wearable apparatus 100.

In this case, it can be seen that mobile communication is possible, but it is not clear whether or not communication is possible, and there is period in which neither of the cases illustrated in FIGS. 7 and 8 are specified. Even in this case, the control unit 130 may first start to transfer data in a route using mobile communication which is confirmed to be possible.

For example, in a case where measured data is data obtained in a case where exercise is performed outdoors, there is no gateway apparatus 300 using Wi-Fi communication on the periphery, and the case illustrated in FIG. 8 often occurs. In other words, since the state illustrated in FIG. 8 more easily occurs than the state illustrated in FIG. 7 depending on use situations, upload using mobile communication is started without waiting for a search result of Wi-Fi communication, and thus the time required to complete the transfer can be reduced. Even if communication path information indicating that Wi-Fi communication is possible (FIG. 7) as a search result of Wi-Fi communication is obtained, it is enough to switch to Wi-Fi communication after the communication path information is received, and thus it does not cause any problem to start to transfer data to the information terminal 200 through Bluetooth communication in advance.

In a case where communication path information indicating that connection using Wi-Fi communication (first wireless communication method) is possible is received by the second communication unit 120 (the case in FIG. 7 mainly occurs, but the case in FIG. 9 may occur), the control unit 130 selects transfer of transfer data using Wi-Fi communication, and the first communication unit 110 performs transfer of the transfer data through Wi-Fi communication. As described above, Wi-Fi communication has a higher transfer speed than Bluetooth communication. Unlike the examples shown in steps S113 to S115, connection can be performed from the gateway apparatus 300 to the Internet (network NE) without using the information terminal 200. In the above-described way, transfer data can be transferred at a high speed.

Specifically, as illustrated in FIG. 6, the first communication unit 110 searches for the gateway apparatus 300 under the control of the control unit 130 (step S116), and performs connection to the gateway apparatus 300 by using an SSID and a password in a case where the connectable gateway apparatus 300 is found (step S117). In other words, the first communication unit 110 performs Wi-Fi communication (communication in the first wireless communication method) with the gateway apparatus 300 on the basis of the authentication information received by the second communication unit 120 through Bluetooth communication (second wireless communication method) in step S105.

After the connection is performed, the first communication unit 110 transfers the transfer data to the server system 500 through Wi-Fi communication via the gateway apparatus 300 (steps S118 and S119). Specifically, the control unit 130 selects a path A1 in FIG. 7 or a path C1 in FIG. 9.

As described above, in the present embodiment, there is a case where upload is started by using mobile communication regardless of the connectability using Wi-Fi communication. Thus, communication path information indicating that Wi-Fi communication is possible may be received by the second communication unit 120 in a state in which transfer data is transferred to the information terminal 200 through Bluetooth communication.

Specifically, there may be a case where a situation (FIG. 8) in which a user understands that Wi-Fi communication is not possible changes to a situation (FIG. 7) in which Wi-Fi communication is possible due to the user moving around a home thereof or a free spot. Alternatively, there may be a case where both of Wi-Fi communication and mobile communication are initially available (FIG. 7), and then upload is first started by using mobile communication due to the above-described search time difference.

Anyway, the control unit 130 may select transfer of transfer data using Wi-Fi communication, and the first communication unit 110 may transfer the transfer data through Wi-Fi communication, in a stage of recognizing that Wi-Fi communication is possible. In this case, the second communication unit 120 may continuously transfer data to the information terminal 200 (and the information terminal 200 may continuously transfer data through mobile communication), but communication in the second communication unit 120 may be stopped. In other words, the control unit 130 may perform control of stopping transfer of transfer data using Bluetooth communication, and starting transfer of the transfer data using Wi-Fi communication. In the above-described way, it is possible to transfer data at a high speed by prioritizing Wi-Fi communication regardless of a situation of data transfer using Bluetooth communication and mobile communication.

There may be a case where communication path information indicating that neither connection using Wi-Fi communication and mobile communication is possible is received by the second communication unit 120. In this case, as illustrated in FIG. 10, connection to the network NE (server system 500) cannot be performed by using either a direct path from the wearable apparatus 100 or a path via the information terminal 200.

In this case, the control unit 130 selects transfer of transfer data using Bluetooth communication in order to accumulate the transfer data in the information terminal 200 as indicated by a path D in FIG. 10, and the second communication unit 120 transfers the transfer data to the information terminal 200 through Bluetooth communication.

In this case, the information terminal 200 performs a search for the gateway apparatus 300 which is a connection target and a search for the base station 400 using mobile communication at a predetermined interval. In a case where the information terminal 200 side determines that the target gateway apparatus 300 is connectable or determines that mobile communication can be performed (any one of the cases in FIGS. 7 to 9), the second communication unit 220 notifies the wearable apparatus 100 (second communication unit 120) that upload can be started through Bluetooth communication. A process after the notification is the same as in the above-described example.

Alternatively, in the case illustrated in FIG. 10, the information terminal 200 may perform transfer of transfer data (upload of the transfer data to the server system 500). In a case where a situation changes to any of the cases illustrated in FIGS. 7 to 9 due to movement of a user or the like, the transfer data may be uploaded to server system 500 by using an available communication path according to a determination in the control unit 240 of the information terminal 200. A specific path in this case may be A2 and A3 in FIG. 7, B in FIG. 8, and C2 in FIG. 9. In this case, if the wearable apparatus 100 performs local upload (data transfer) on the information terminal 200, the wearable apparatus 100 is not required to participate in the subsequent transfer. Since the wearable apparatus 100 is not required to hold the transfer data, it is possible to give a margin to a storage capacity of the storage unit 160 or to reduce a processing load in the control unit. 130.

### 4. MODIFICATION EXAMPLES

In the above description, a description has been made of an example in which information indicating a connection situation of the information terminal 200, that is, whether or not the information terminal 200 can perform Wi-Fi communication and the information terminal 200 can perform mobile communication is used as communication path information, and the control unit 130 selects a communication math on the basis of the communication path information.

However, information which is different from the information may also be used in a determination of a communication path. For example, the control unit 130 may select a communication path on the basis of communication path information and state information of the wearable apparatus 100 in step 8112 in FIG. 5. Here, the state information of the wearable apparatus 100 is information including at least one of power information of the wearable apparatus 100, and information regarding an amount of transfer data which is a transfer target of the wearable apparatus 100.

In the above-described way, it is possible to select an appropriate communication path according to power (in a narrow sense, a battery residual capacity) of the wearable apparatus 100, or an amount of transfer data.

For example, even in a case where communication path information indicating that connection using Wi-Fi communication can be performed is received by the second communication unit 120, the control unit 130 may select transfer of transfer data using Bluetooth communication on the basis of the state information of the wearable apparatus 100, and the second communication unit 120 may transfer the transfer data to the information terminal 200 through. Bluetooth communication.

More specifically, in a case where it is determined that a battery residual capacity of the wearable apparatus 100 is small on the basis of the power information, or an amount of transfer data is small on the basis of the information regarding a data amount, Bluetooth communication is prioritized rather than Wi-Fi communication.

Here, a battery residual capacity being small indicates that, for example, a battery voltage is lower than a predetermined threshold voltage. An amount of transfer data being small indicates that a data amount is less than a predetermined threshold value. A data amount may be determined in the bit (byte) unit, and may be determined in the packet unit. Alternatively, a data amount may be estimated from the time (measurement time) at which the wearable apparatus 100 performs a measurement operation.

As described above, in Wi-Fi communication, power consumption of data transfer is larger than i. Bluetooth communication. Thus, if Wi-Fi communication is prioritized even in a case where a battery residual capacity is small, there is concern that the wearable apparatus 100 may not perform a continuous operation. In relation to this fact, Bluetooth communication requires relatively small power consumption, and thus an operation time of the wearable apparatus 100 can be increased.

In a case where an amount of transfer data is small, the time required for transfer completion is reduced even if a transfer rate (a data amount which can be transferred per unit time) is low. In other words, in a case where an amount of transfer data is small, the influence on a user's convenience is small, and power consumption can be reduced, even if Bluetooth communication whose speed is relatively low is used.

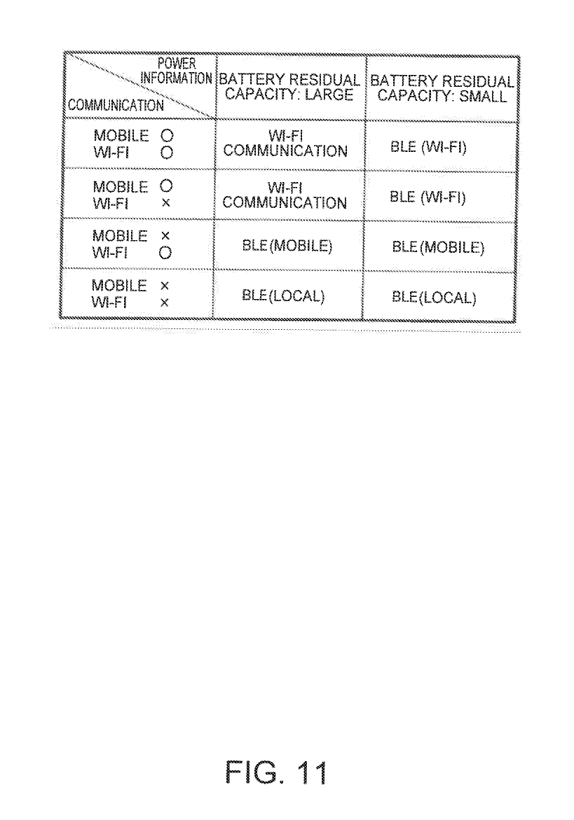

FIG. 11 illustrates an example of selecting a communication path in a case where power information is taken into consideration. In a case where a battery residual capacity is sufficiently large (battery residual capacity: large) Wi-Fi communication may be prioritized. Thus, in a case where Wi-Fi communication is possible, the first communication unit 110 transfers transfer data through Wi-Fi communication (the path A1 in FIG. 7, and the path C1 in FIG. 9). In FIG. 11, “O” indicates communication possible, and “X” indicates communication impossible.

In a case where Wi-Fi communication is not possible but mobile communication is possible, the second communication unit 120 transfers transfer data to the information terminal 200 through Bluetooth communication, and the information terminal 200 performs upload by using mobile communication (the path B in FIG. 8). In FIG. 11, this communication path is indicated by “BLE (mobile)”.

In a case where neither of Wi-Fi communication and Bluetooth communication are possible, the second communication unit 120 transfers transfer data to the information terminal 200 through Bluetooth communication so that the transfer data is locally accumulated in the information terminal 200 (the path B in FIG. 10). In FIG. 11, this communication path is indicated by “BLE (local)”.

On the other hand, in a case where a battery residual capacity is small (battery residual capacity: small), even if Wi-Fi communication is possible (FIGS. 7 and 9), the second communication unit 120 transfers transfer data to the information terminal 200 through Bluetooth communication, and the information terminal 200 performs upload through Wi-Fi communication. In FIG. 11, this communication path is indicated by “BLE (Wi-Fi)”. Specifically, the control unit 130 may select the path in FIG. 7 or the path C2 in FIG. 9. In a case where mobile communication is also possible as illustrated in FIG. 7, the information terminal 200 may upload transfer data through mobile communication. Specifically, the control unit 130 may select the path A3 in FIG. 7.

In a case where Wi-Fi communication is not possible, a communication path is used in the same manner as in a case where a battery residual capacity is sufficient. In FIG. 11, a description has been made of an example of using power information, but this may also be applied to a case of using data amount information.

As mentioned above, state information of the wearable apparatus 100 is used to select a communication path, and thus a communication path can be selected according to situations. Power information and data amount information are not limited to being used separately, and both of the pieces of information may be used together.

Information other than power information or data amount information may be used as state information of the wearable apparatus 100. For example, in a case where a user uses the wearable apparatus 100 for the purpose of exercise, it is considered that the user is much interested in measured data during the exercise and is not much interested in measured data during resting. Therefore, information (measured data characteristic information) regarding data measured by the wearable apparatus 100 may be used as state information. Whether or not the wearable apparatus 100 measures data during an exercise (whether or not the user is in an exercise state) maybe determined on the basis of body motion information, may be determined on the basis of biological information, and may be determined on the basis of both of the pieces of information. In this example, in a case where the wearable apparatus 100 measures data during an exercise, Wi-Fi communication may be prioritized, and in a case where the wearable apparatus 100 measures data during resting, Bluetooth communication may be prioritized. In a broader sense, the control in 130 may select a communication path in which Wi-Fi communication is prioritized for data having high importance (data which preferably transferred at a high speed), and may select a communication path in which Bluetooth communication is prioritized for data having low importance (data which is enough to be transferred at a low speed).

Also in the present modification example, the information terminal 200 side (control unit 240) may perform processes to selection of a communication path, and may transmit information indicating the selected communication path to the wearable apparatus 100 as communication path information. However, state information of the wearable apparatus 100 is expected to be acquired in the wearable apparatus 100 (in a narrow sense, the control unit 130) Therefore, in a case where the information terminal 200 side selects a communication path by using state information of the wearable apparatus 100, the wearable apparatus 100 is required to transmit state information to the information terminal 200. The state information may be transmitted through Bluetooth communication (the second communication unit 120).

As mentioned above, the embodiments to which the invention is applied and the modification examples thereof have been described, but the invention is not limited to each embodiment and a modification example thereof, and can be embodied by modifying constituent elements within the scope without departing from the spirit of the invention in an implementation stage. Various inventions may be formed by combining a plurality of constituent elements disclosed in the above-described respective embodiments or modification examples with each other as appropriate. For example, some of all the constituent elements disclosed in the above-described respective embodiments or modification examples may be omitted. Constituent elements described in different embodiments or modification examples may be combined with each other as appropriate. In the specification or the drawings, the terminologies which are mentioned at least once along with different terminologies which have broader meanings or the same meanings may be replaced with the different terminologies in any location of the specification or the drawings. As mentioned above, various modifications or applications may occur within the scope without departing from the spirit of the invention.

What is claimed is:

1. A wearable apparatus comprising:
a first communication circuit that performs Wi-Fi communication with a gateway apparatus;
a second communication circuit that performs Bluetooth communication with an information terminal that can also perform Wi-Fi communication with the gateway apparatus; and
a processor that controls the first communication circuit and the second communication circuit,
wherein the second communication circuit receives communication path information from the information terminal through the Bluetooth communication, and
wherein the processor selects either the Wi-F communication or the Bluetooth communication based on the communication path information and (ii) transfers transfer data through the selected communication.

2. The wearable apparatus according to claim 1,
wherein the second communication circuit receives authentication information, which is used for an authentication process in the gateway apparatus during the Wi-Fi communication, through the Bluetooth communication, and
wherein the first communication circuit performs the Wi-Fi communication with the gateway apparatus using the authentication information.

3. The wearable apparatus according to claim 2,
wherein the second communication circuit receives the authentication information during pairing of the Bluetooth communication with the information terminal.

4. The wearable apparatus according to claim 2,
wherein the authentication information includes a service set identifier (SSID) and a password corresponding to the gateway apparatus.

5. The wearable apparatus according to claim 1,
wherein the second communication circuit makes to the information terminal a notification request for the communication path information terminal, and receives the communication path information from the information terminal in response to the notification request.

6. The wearable apparatus according to claim 5,
wherein the second communication circuit makes the notification request at a transfer time for the transfer data.

7. The wearable apparatus according to
wherein the transfer data is data that is measured by a sensor.

8. The wearable apparatus according to claim 1,
wherein, if the communication path information received by the second communication circuit indicates that connection using the Wi-Fi communication is possible, the processor selects transfer of the transfer data using the Wi-Fi communication, and the first communication circuit transfers the transfer data through the Wi-Fi communication.

9. The wearable apparatus according to claim 1,
wherein the information terminal is a terminal that can perform mobile communication, and
wherein, if the communication path information received by the second communication circuit indicates that connection using the mobile communication is possible, the processor selects transfer of the transfer data using the Bluetooth communication to transfer data through the mobile communication of the information terminal, and the second communication circuit transfers the transfer data to the information terminal through the Bluetooth communication.

10. The wearable apparatus according to claim 9,
wherein if the communication path information received by the second communication unit indicates that connection is not possible by either the Wi-Fi communication or the mobile communication, the processor selects transfer of the transfer data using the Bluetooth communication to accumulate the transfer data in the information terminal, and the second communication circuit transfers the transfer data to the information terminal through the Bluetooth communication

11. The wearable apparatus according to claim 9,
wherein, if the communication path information indicates that the Wi-Fi communication is possible and is received by the second communication circuit in a state in which the transfer data is transferred to the information terminal through the Bluetooth communication, the processor stops transfer of the transfer data using the Bluetooth communication and starts transfer of the transfer data using the Wi Fi communication.

12. The wearable apparatus according to claim 8,
wherein, even if the communication path information indicating that connection using the Wi-Fi communication is possible is received by the second communication circuit, the processor selects transfer of the transfer data using the Bluetooth communication based on state information of the wearable apparatus, and the second communication circuit transfers the transfer data to the information terminal through the Bluetooth communication.

13. The wearable apparatus according to claim 12,
wherein the state information of the wearable apparatus includes at least one of power information of the wearable apparatus and data amount information of the transfer data, which is a transfer target of the wearable apparatus.

14. An information terminal comprising:
a first communication circuit that performs Wi-Fi communication with a gateway apparatus;
a second communication circuit that performs Bluetooth communication with a wearable apparatus that can also perform Wi-Fi communication with the gateway apparatus; and
a processor that controls the first communication circuit and the second communication circuit,
wherein the processor (i) generates communication path information for setting a communication path, which is used for transfer of transfer data in the wearable apparatus, based on a search result of the gateway apparatus in the first communication circuit and (ii) controls the second communication circuit to transmit the communication path information to the wearable apparatus through the Bluetooth communication.

15. The information terminal according to claim 14, further comprising:
a third communication circuit that performs mobile communication,
wherein the second communication circuit receives the transfer data from the wearable apparatus through the Bluetooth communication, and
wherein the third communication circuit transfers the transfer data through the mobile communication.

16. A communication system comprising:
the wearable apparatus according to claim 1; and
the information terminal.

17. A communication system comprising:
the wearable apparatus according to claim 2; and
the information terminal.

18. An electronic apparatus comprising:
a first communication circuit that performs communication with a gateway apparatus according to a first wireless communication method;
a second communication unit that performs communication with an information terminal apparatus, which can also perform communication with the gateway apparatus according to the first wireless communication method, according to a second wireless communication method that is different frog the first wireless communication method; and
a processor that controls the first communication circuit and the second come communication circuit,
wherein the second communication circuit receives communication path information from the information terminal according the second wireless communication method, and
wherein the processor (i) selects either the first wireless communication method or the second wireless communication method based on the communication path information and (ii) transfers transfer data through the selected wireless communication method.

19. The electronic apparatus according to claim 18,
wherein the second wireless communication method is ad hoc communication between the information terminal and the electronic apparatus.

20. A communication control method for a wearable apparatus including a first communication circuit, which performs Wi-Fi communication with a gateway apparatus, and a second communication circuit, which performs Bluetooth communication with an information terminal that can also perform Wi-Fi communication with the gateway apparatus, the method comprising:
receiving, through the Bluetooth communication, communication path information from the information terminal by way of the second communication circuit;
selecting either the Wi-Fi communication or the Bluetooth communication based on the received communication path information; and
transferring transfer data through the selected communication.

21. A wearable apparatus comprising:
a Wi-Fi communication circuit configured to communicate with a gateway apparatus;
a Bluetooth communication circuit; and
a processor that, in response to communication path information received from an information terminal by way of the Bluetooth communication circuit, transfers transfer data by way of the Wi-Fi communication circuit or the Bluetooth communication circuit.
